(19) United States
(12) Patent Application Publication
(10) Pub. No.: US 2004/0006417 A1
(43) Pub. Date: Jan. 8, 2004

(54) Transmission identification apparatus

(76) Inventor: Anthony Selby, Edgewood, MD (US)

Correspondence Address: Hollstein Keating Cattell Johnson & Goldstein P.C., Willow Ridge Executive Office Park, Suite 301, 750 Route 73 South, Marlton, NJ, 08053, US

(21) Appl. No.: 10/190,176

(22) Filed: Jul. 3, 2002

(51) Int. Cl. G06F 19/00

(52) U.S. Cl. 701/32; 701/51

(57) ABSTRACT

A self-contained, portable apparatus is disclosed which serves to identify models of vehicle transmissions. The apparatus comprises a self-contained control box containing a power source, such as an electrical battery unit. The power source emits a signal through an electrical line located within a wiring harness connected to the control box. The wiring harness has an end connector which is configured to be matingly and removably connected with a receptacle connection at the transmission. The receptacle connection is the point of attachment between the transmission's electrical control unit and the transmission itself. When the electrical control unit is disconnected from the receptacle connection and the wiring harness of the identification apparatus is connected, the signal from the power source is transmitted through the wiring harness to the transmission, where it identifies the TransID level or model. An identifying signal is sent by the transmission and received by the identification apparatus and an indicator light on the control box indicates the TransID level. The apparatus is designed to indicate a plurality of TransID levels, by means of separate transmitting and identifying signals and separate indicator lights located on the control box.

### BACKGROUND OF THE INVENTION

State of the art vehicle transmissions are still constantly being improved and upgraded, as technology advances. However, very often newer transmission models are updated versions of prior models; and, in this way, new technology results in efficiency in product development, economy of manufacture, ease of and more simple maintenance and repair, and increased availability of replacement parts. For instance, Allison Transmission has developed and is manufacturing a transmission identification system (TransID) for transmissions employing electrical control units (ECU) which assist in the operation of primary and secondary transmission systems. The TransID feature serves the control system by permitting minor transmission changes which require calibration changes, while retaining both the original transmission and the original calibrated ECU. TransID reduces the need for transmission technicians to use cross-referenced lists of transmissions and calibrated ECUs when changes to the transmissions are to be made. Technicians can continue to order specific transmission components and calibrated ECUs and receive all changes made to the particular transmissions and their changed calibrations. This reduces the number of major transmission changeovers with which the technician must contend during the maintenance and repair process.

The basis for the TransID system is the creation of a TransID wire which provides a signal to the ECU, signifying the TransID level or model of the transmission. This wire is, at first, connected directly to an analog ground which signals the first TransID level, TID1 (the initially designed transmission model). Subsequent TransID levels (later models of transmissions with enhanced operating features) are indicated by connecting the TransID wire in sequence to ground solenoids which relay identification signals from the various TransID levels. A connection point of the TransID wire at the transmission provides the signal which tells the ECU which calibration is required by the transmission.

While many of the components between the various generations or models of transmission, e.g. TransID 1, TransID 2, etc., are the same, the newer features in later transmission models are often not compatible with similar features in prior models. In fact, many of the TransID parts of different TransID transmission levels should not be mixed with different levels of transmissions. Part replacement requires the correct TransID version of the part. For instance, Allison's TransID 1 model of transmission employs a transmission fluid temperature sensor which controls transmission shift points. The sensor operates such that as the temperature increases, the resistance increases. In the next generation of transmissions, TransID 2, the sensor operates on the basis of a temperature increase and a corresponding decrease in resistance. The control system in the TransID 2 system recognizes this newer and more accurate sensor and will not work properly with the sensor in use on the TransID 1 transmission.

The proper TransID part can be identified in parts lists which are provided with the transmission, when it is initially built. Unfortunately, transmission technicians are often unaware of or ignore transmission identification and will unknowingly attempt to install incompatible components. This not only will fail to resolve the repair problem, but cause additional malfunction, resulting in major repair expense and sometimes necessitate a complete overhaul of the transmission. However, by ensuring that all transmission components for a particular TransID model transmission are the correct components for that model, repairs are simplified and are done easily and correctly, obviously resulting in enormous savings of repair time and expense.

As a result, a transmission identification apparatus which can readily, easily, and accurately identify TransID transmission models, so that the transmission technician can initially be sure of the model on which he or she is working, would be of great assistance in the repair and maintenance of such transmissions. No such apparatus currently exists.

### SUMMARY OF THE PRESENT INVENTION

It is thus an object of the present invention to provide a transmission identification apparatus which is adaptable for use with and can accurately identify various levels or models of transmissions.

It is another object of the present invention to provide a transmission identification apparatus which ensures that components designed for a given model of transmission are used only for that transmission.

It is a further object of the present invention to provide a transmission identification apparatus which identifies TransID levels or models so that components designed for one model of transmission are not improperly used with another model.

It is still another object of the present invention to provide a transmission identification apparatus which can be used on existing transmissions which employ electrical control units.

It is a further object of the present invention to provide a transmission identification apparatus which will easily and simply identify TransID levels or models for ease of transmission repair and part replacement.

It is still another object of the present invention to provide a transmission identification apparatus which is portable and can readily and quickly be connected and disconnected from ECU receptacles associated with existing transmissions.

These and other advantages and benefits of the transmission identification apparatus of the present invention are provided in the present invention which comprises a self-contained control box containing a power source, such as an electrical battery unit. The power source emits a signal through an electrical line located within a wiring harness connected to the control box. The wiring harness has an end connector which is configured to be matingly and removably connected with a receptacle connection at the transmission. The receptacle connection is the point of attachment between the transmission's electrical control unit and the transmission itself. When the electrical control unit is disconnected from the receptacle connection and the wiring harness of the identification apparatus is connected, the signal from the power source is transmitted through the wiring harness to the transmission, where it identifies the TransID level or model. An identifying signal is sent by the transmission and received by the identification apparatus and an indicator light on the control box indicates the TransID level. The apparatus is designed to indicate a plurality of TransID levels, by means of separate transmitting and identifying signals and separate indicator lights located on the control box.

The novel features which are considered as characteristic of the invention are set forth in particular in the appended claims. The invention, itself, both as to its design, construction, and use, together with additional features and advantages thereof, are best understood upon review of the following detailed description with reference to the accompanying drawings.

### BRIEF DESCRIPTION OF THE DRAWINGS

FIG. 1 shows circuitry between the electrical control unit (ECU) and the transmission to indicate TransID level 1 transmission.

FIG. 2 shows circuitry between the ECU and the transmission to indicate TransID level 2 transmission.

FIG. 3 shows the control box, wiring harness, and end connector of the present invention.

FIG. 4 shows the manner of connection between the end connector and the transmission.

FIG. 5 is an end view showing the mating components (plugs) of the end connector.

FIG. 6 is an end view showing the mating components (pins) of the transmission connection receptacle.

FIG. 7 is an electrical schematic showing the present invention and its connection to transmissions to be identified.

FIG. 8 is an electrical schematic showing the present invention, with future transmission identification circuitry, and its connection to transmissions to be identified.

### DETAILED DESCRIPTION OF THE INVENTION

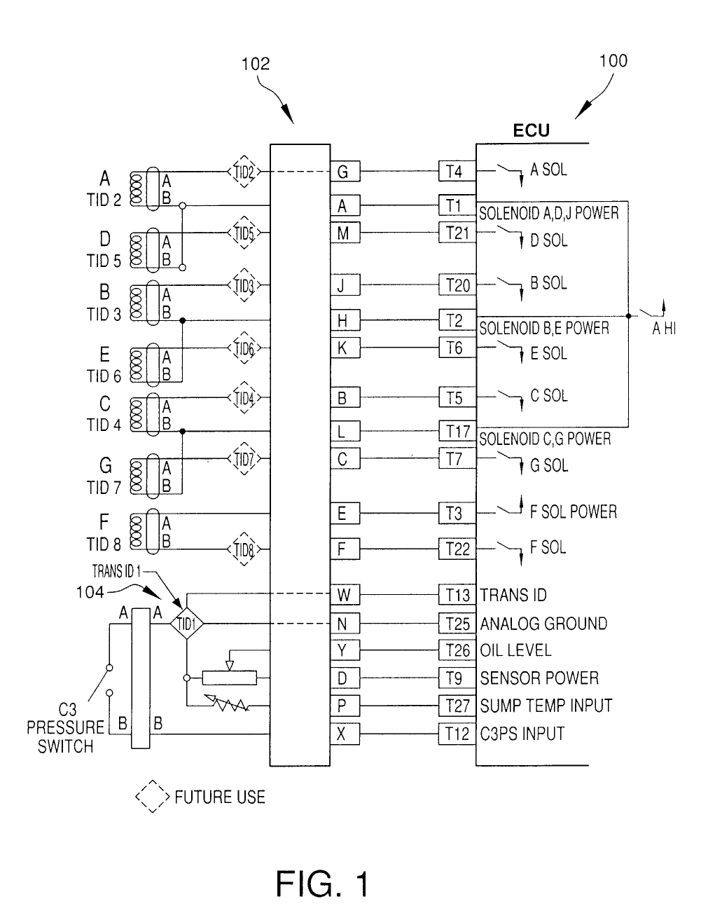

FIG. 1 shows the circuitry which connects electrical control unit (ECU) 100 to transmission 102 and Trans ID level 1 circuitry 104. ECU 100 uses the appropriate software to transmit calibrated signals to operate and control various transmission systems. In particular herein, ECU 100 sends a modulated signal from its TransID wire connection T13 to terminal W of transmission 102. The signal passes through TransID circuitry 104, identifying TransID 1, TID1 in FIG. 1. The signal is returned via terminal N of transmission 102 to analog ground T25, which relays to ECU 100 the TransID 1, level one identification.

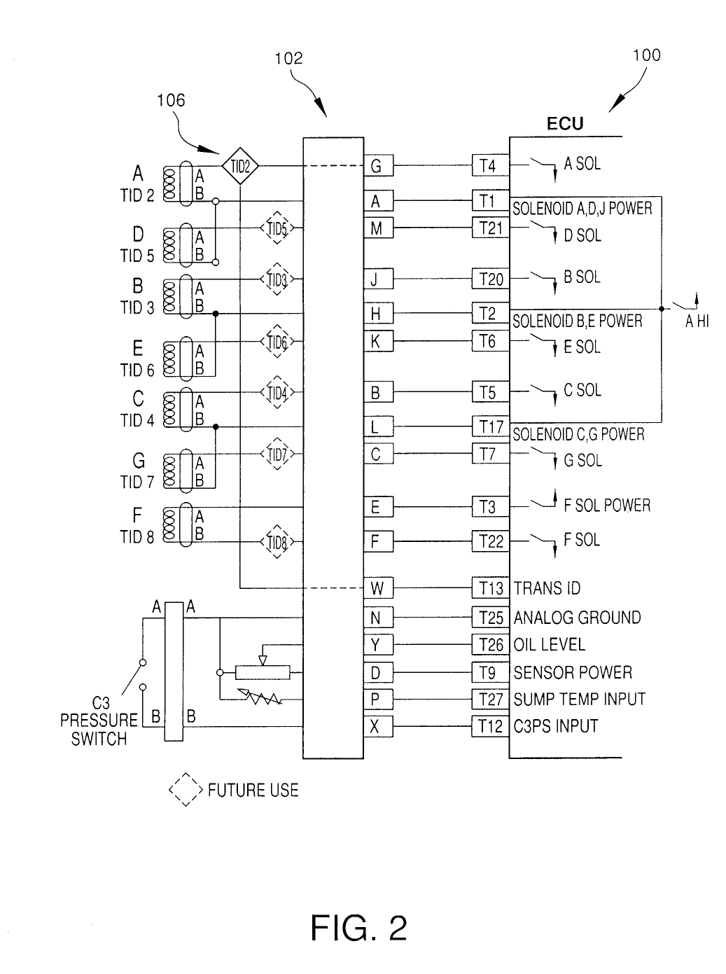

FIG. 2 shows the circuitry which connects ECU 100 to transmission 102 and TransID level 2 circuitry 106. The modulated signal from ECU 100 is again transmitted via TransID connection T13 to terminal W of transmission 102. For this identification the signal passes through to TransID circuitry 106, identifying TransID2, TID2 in FIG. 2. The signal is returned via terminal G of transmission 102 to ground solenoid T4, which relays to ECU 100 the TransID 2, level two identification. Circuitry for the identification of future transmission levels, T1D3 through T1D8, are provided, each being configured to receive the TransID signal via terminal W of transmission 102 and to relay identification signals to ground solenoids of ECU 100 as follows:

TID3 relays the signal via terminal J to solenoid T20;

TID4 relays the signal via terminal B to solenoid T5;

TI05 relays the signal via terminal M to solenoid T21;

TI06 relays the signal via terminal K to solenoid T6;

TI07 relays the signal via terminal C to solenoid T7; and

TI08 relays the signal via terminal I to solenoid T22.

The transmission identification apparatus of the present invention is designed to replace the TransID signal sent from ECU 100 and to provide a substitute signal which is transmitted through transmission 102 and TransID circuitry, e.g. 104 and 106. The apparatus then receives the return signal from the TransID circuitry and the TransID level is identified on the apparatus.

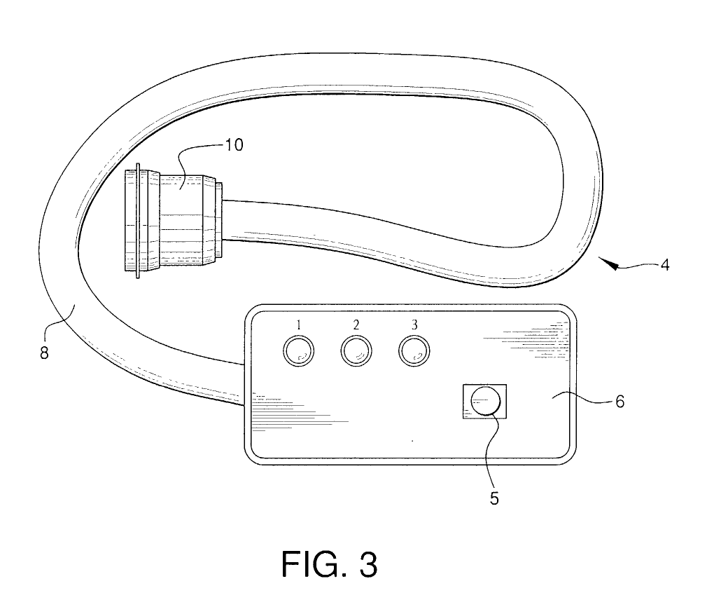

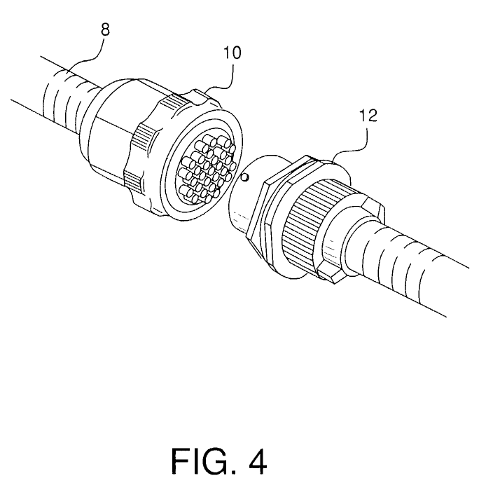

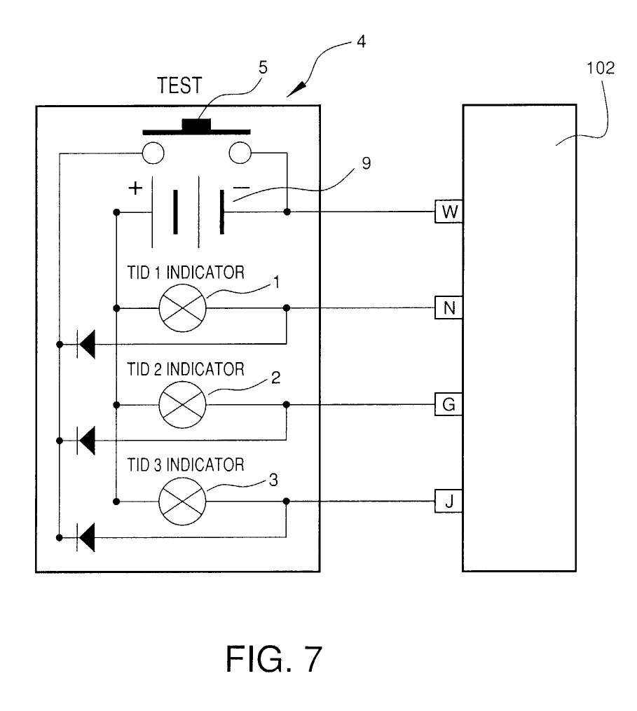

More specifically, as seen in FIG. 3, transmission identification apparatus 4 comprises control box 6, with indicator lights 1, 2 and 3, and connecting an electrical cable or wiring harness 8 with end connector 10. A power source 9 (FIG. 7), which may be an electrical battery unit, is located in control box 6. As seen in FIG. 4, connector 10 is configured to be matingly and removably connected to transmission connection receptacle 12 attached to transmission circuitry. During normal vehicle operation, transmission connection receptacle 12 is configured to be matingly and removably connected to the cable from the ECU of the transmission.

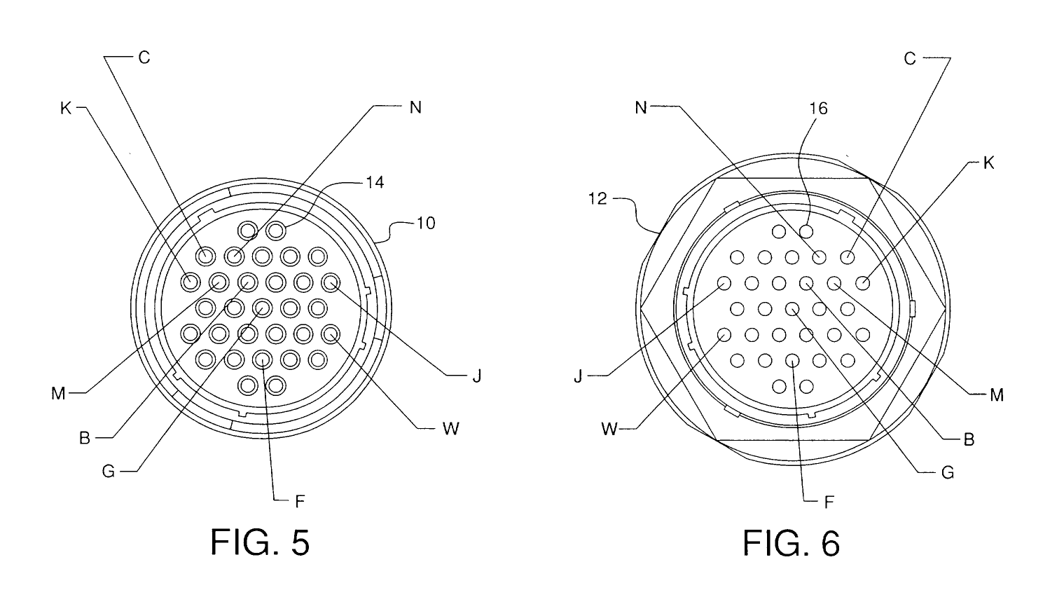

FIGS. 5 and 6 show the mating components of end connector 10 of apparatus 4 and transmission connection receptacle 12. End connector 10 is comparable in configuration to the end connector which is used to connect the ECU, via wiring harness, to transmission connection 12. Connector 10 comprises a plurality of end terminal plugs 14, individual terminal plugs being designated as W, N, G, J, B, M, K, C, and F in FIG. 5. Terminal plugs 14 transmit the electrical signal from power source 9. Each plug 14 is configured to be inserted onto corresponding terminal pin receptacles 16, located on transmission connection receptacle 12. Terminal pins 16, designated in FIG. 6 as W, N, G, J, B, M, K, C and F, thus correspond to pin receptacles 16 terminal plugs 14 of end connector 10. It is thus readily apparent that when end connector 10 and transmission connection receptacle 12 are joined, a signal transmitted through wiring harness 8 via terminal plug 14 W will be received via terminal pin receptacle 16 W. A signal transmitted via terminal pin receptacle 16 N will be received by terminal plug 16 N, etc.

FIG. 7 shows an electrical schematic of transmission identification apparatus 4 and its interconnection with transmission 102 with its TransID circuitry. As seen in FIG. 7, power source 9 in transmission identification apparatus 4 is electrically wired such that the signal emanating from the power source is transmitted to transmission 102 via terminal plug and pin connection W. The signal passes through TransID circuitry 104 (FIG. 1) of transmission 102 and returns to apparatus 4 via terminal plug and pin connection N where TID1 indicator light 1, wired in series with the return signal, is lit, thereby identifying the transmission as a TransID 1, transmission.

Similarly, when the signal from power source 9, transmitted to transmission 102 via connection W, returns via terminal plug and pin connection G, TID2 indicator light 2 is lit, identifying the transmission as a TransID 2 transmission. When the signal from power source 9, transmitted to transmission 102 via connection W, returns via terminal plug and pin connection G, TID 3, indicator light 3 is lit, identifying the transmission as a TransID 3 transmission. Test button 5 is provided to test the operability of lamps in use as indicators 1, 2, and 3.

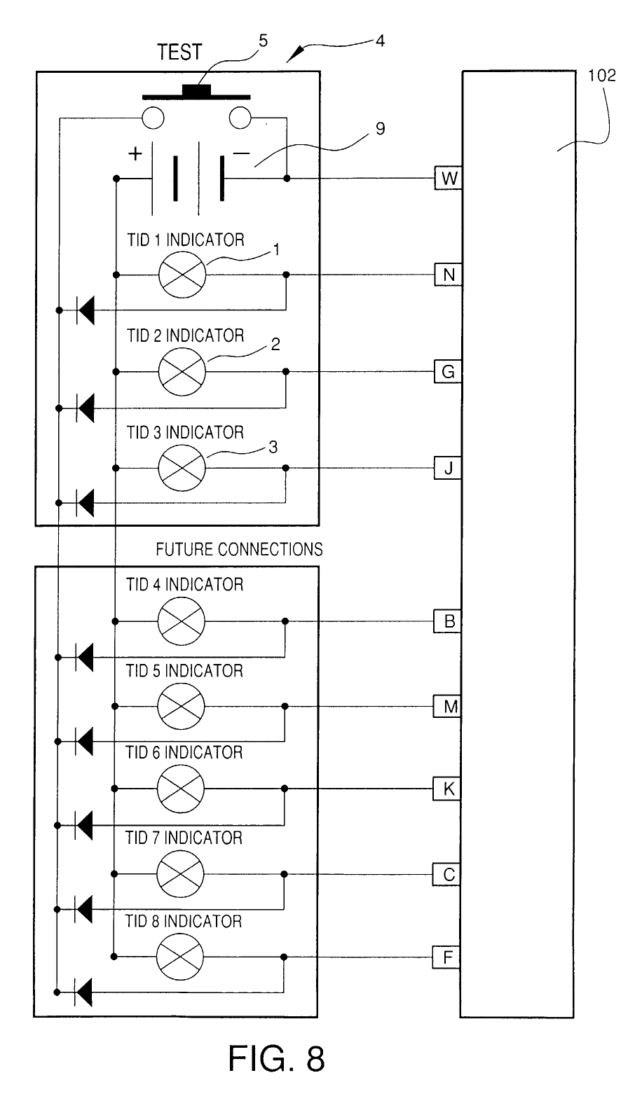

FIG. 8 anticipates the use of future identification connections to be incorporated into apparatus 4, to identify future generators of transmissions, TID4 to TID8, via terminal plug and pin connection B, M, K, C, and F respectively.

In use, when the transmission technician seeks to identify the model of transmission on which he will begin maintenance or repair, the cable connecting the TransID wire T13 of the ECU to transmission 102 is disconnected at transmission connection receptacle 12. Wiring harness 8 of identification apparatus 4 is connected to transmission connection receptacle 12 via end connector 10. Power source 9 sends its signal to the transmission and the appropriate indicator light, either 1, 2 or 3 lights, identifying the TransID level.

In this manner, a portable, efficient transmission identification apparatus is provided which the technician can use to easily and quickly determine the TransID model transmission on which work will be done. This results in the proper replacement parts being used and the maintenance and repair operation for each model of transmission being performed correctly for that respective model of transmission.

While the identification apparatus of the present invention is disclosed for use in identifying vehicle transmissions, it is contemplated that the apparatus can be used effectively with any transmission or similar system in which identification of the model or type of transmission or system is desired.

Certain novel features and components of this invention are disclosed in detail in order to make the invention clear in at least one form thereof. However, it is to be clearly understood that the invention as disclosed is not necessarily limited to the exact form and detail as disclosed, since it is apparent that various modifications and changes may be made without departing from the spirit of the invention.

1. An apparatus for identifying models of vehicle transmissions comprising:
(a) power source means for generating a signal to the model of transmission to be identified;
(b) means to transmit the signal to the transmission;
(c) means to receive an identifying signal from the transmission which identifies the transmission model; and
(d) means to indicate the transmission model upon receipt of the identifying signal from the transmission.

2. The apparatus as in claim 1 further comprising means to connect both the signal transmitting means and the identifying signal receiving means to the transmission.

3. The apparatus as in claim 2 wherein a connector comprises the means to connect the signal transmitting means and the identifying signal receiving means to the transmission.

4. The apparatus as in claim 3 wherein the model of transmission to be identified comprises an electronic control unit which is matingly connected to the transmission at a transmission connection terminal and the connector is configured to be matingly connected to the connection terminal.

5. The apparatus as in claim 3 wherein the connector comprises elements which are configured to be matingly connected to corresponding elements at the transmission.

6. The apparatus as in claim 4 wherein the connector comprises elements which are configured to be matingly connected to corresponding elements of the transmission connection terminal.

7. The apparatus as in claim 1 wherein the means to indicate the transmission model comprises an indicator light.

8. The apparatus as in claim 1 further comprising a plurality of identifying signal receiving means, each said receiving means identifying a different model of transmission.

9. The apparatus as in claim 1 further comprising a plurality of transmission model indicator means, whereby each said indicator means identifies a different model of transmission depending on the transmission identification received from the identifying signal.

10. The apparatus as in claim 9 further comprising a plurality of identifying signal receiving means, each said receiving means identifying a different model of transmission and each such identification being indicated by one of said plurality of indicator means.

11. An apparatus for identifying models of vehicle transmissions comprising:
(a) a control box containing a power source for generating a signal to the model of transmission to be identified;
(b) a wiring harness extending from the control box, said wiring harness comprising first means to transmit the signal to the model of transmission to be identified and second means to receive an identifying signal from the transmission which identifies the transmission model;
(c) a connector attached to the wiring harness to matingly connect the control box to the model of transmission to be identified; and
(d) means to indicate the transmission model upon receipt of the identifying signal from the transmission.

12. The apparatus as in claim 11 wherein the model of transmission to be identified comprises an electronic control unit which is matingly connected to the transmission at a transmission connection terminal and the connector is configured to be matingly connected to the connection terminal.

13. The apparatus as in claim 11 wherein the connector comprises elements which are configured to be matingly connected to corresponding elements at the transmission.

14. The apparatus as in claim 12 wherein the connector comprises elements which are configured to be matingly connected to corresponding elements of the transmission connection terminal.

15. The apparatus as in claim 11 wherein the means to indicate the transmission model comprises an indicator light.

16. The apparatus as in claim 11 further comprising a plurality of identifying signal receiving means, each said receiving means identifying a different model of transmission.

17. The apparatus as in claim 11 further comprising a plurality of transmission model indicator means, whereby each said indicator means identifies a different model of transmission depending on the transmission identification received from the identifying signal.

18. The apparatus as in claim 17 further comprising a plurality of identifying signal receiving means, each said receiving means identifying a different model of transmission and each such identification being indicated by one of said plurality of indicator means.

19. A method of identifying models of vehicle transmissions comprising the steps of:
(a) providing a transmission identification apparatus with a power source and means for transmitting and receiving signals;
(b) generating a signal from the power source to the model of transmission to be identified, via the signal transmitting means;
(c) receiving an identifying signal from the model of transmission to be identified, via the signal receiving means;
(d) identifying the signal received from the transmission and, in so doing, identifying the model of transmission.

20. The method as in claim 19 further comprising the step of providing the apparatus with an indicator to identify the signal received from the transmission, to identify the model of transmission.
